(19) United States
(12) Patent Application Publication
(10) Pub. No.: US 2010/0063241 A1
(43) Pub. Date: Mar. 11, 2010

(54) HIGH PERFORMANCE POLYASPARTIMIDE RESIN

(75) Inventors: Thomas Joseph Barnell, Dayton, OH (US); Tat Hung Tong, Bellbrook, OH (US); Andrew Karl Klein, Cedarville, OH (US)

Correspondence Address: HOVEY WILLIAMS LLP, 10801 Mastin Blvd., Suite 1000, Overland Park, KS, 66210, US

(73) Assignee: Spirit AeroSystems, Inc., Wichita, KS (US)

(21) Appl. No.: 12/207,347

(22) Filed: Sep. 9, 2008

(51) Int. Cl. C08G 65/38; C08G 73/10

(52) U.S. Cl. 528/170; 528/322

(57) ABSTRACT

New polyaspartimide compositions and methods of forming and using those compositions arc provided. The compositions are formed by reacting a bismaleimide and diamine in a solvent-free environment. The resulting polyaspartimide comprising recurring monomers of

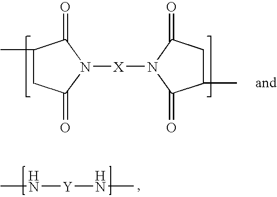

The compositions have properties desirable for use as shape memory polymers as well as in composite products that are useful for building components present in airplanes.

### BACKGROUND OF THE INVENTION

1. Field of the Invention

The present invention is broadly concerned with novel polyaspartimide compositions and methods of forming and using those compositions as shape memory polymers or in low-weight, high-strength composite products.

2. Description of the Prior Art

High performance resins are needed in the aerospace industry that provide weight savings, increased mechanical properties, increased processability in established composite processes, and other unique capabilities. It is very difficult to attain both good processability and performance. High performance thermoplastics, such as polyether ether ketone (PEEK), currently provide the best combination of impact strength, chemical resistance, strength, and stiffness; however, these materials can only be processed in high-temperature extrusion processes or other cost-prohibitive techniques, greatly limiting their use in commercial composites. Epoxies, vinyls, and cyanate ester thermosetting resins can be easily processed via conventional resin transfer molding (RTM) processes, allowing easy incorporation into a variety of carbon, aramid, and glass reinforcements; however, these materials typically cannot provide the impact strength and thermal capabilities needed for high-end applications. Other high-performance reactive resin systems, such as polyimides, provide good performance, but the RTM processing techniques require elaborate degassing, heating, and pressurizing steps over extended time periods. A resin is needed that can provide excellent strength, stiffness, and toughness with high thermal resistance and use temperature, while being processable in conventional RTM processes.

In addition to performance and processability, other capabilities are sought in many aerospace applications. Thermoplastics have an advantage over thermosets in their ability to be reformed and/or welded together after initial processing. This ability to melt can also be disadvantageous, as the composite part is rendered completely useless in temperatures above or near the melt point, whereas thermosets will soften but maintain some degree of mechanical integrity at high temperatures. Unique materials called dynamic elastic modulus resins (DMR) are resins whose elastic modulus changes with a change in temperature of the resin. One such DMR is a shape memory polymer (SMP), which can be defined as a lightly cross-linked thermoset polymer. An SMP allows for high degrees of strain above its glass transition temperature (Tg) and exhibits memory of the form in which it was originally cured. At the Tg of the SMP, a drastic change in the elastic modulus occurs, as the material transitions from the glassy phase to the rubbery phase. This allows the material to be deformed above its Tg and retain the deformed shape when cooled below its Tg. The material will recover its original shape when heated above its Tg unrestrained. The dynamic modulus and shape memory effect allow SMP thermoset materials to be reformed after cure similar to a thermoplastic, without the risk of melting and complete loss of form. Currently, SMP resins exist with Tg values ranging from room temperature to about 150° C. There is no SMP available for applications requiring higher transition temperatures.

Shape memory materials were first developed about twenty-five (25) years ago and have been the subject of commercial development in the last fifteen (15) years. Shape memory materials derive their name from their inherent ability to return to their original “memorized” shape after undergoing a shape deformation. There are principally two types of shape memory materials, shape memory alloys (SMAs) and SMPs, discussed above.

SMAs and SMPs that have been pre-formed can be more easily deformed to a desired shape above their respective Tg values. The SMA and SMP must remain below, or be quenched to below, the Tg while maintained in the desired shape to “lock” in the deformation. Once the deformation is locked in, the SMA, because of its crystalline network, and the SMP, because of its polymer network, cannot return to a relaxed state due to thermal barriers. The SMA or SMP will hold its deformed shape indefinitely until it is heated above its Tg, whereupon the SMA's and SMP's respective stored mechanical strains are released, and the SMA and SMP return to their respective pre-formed, or memory, states.

There are three types of SMPs: (1) partially cured resins, (2) thermoplastics; and (3) fully cured thermoset systems. There arc limitations and drawbacks to the first two types of SMPs. Partially cured resins continue to cure during operation and change properties with every cycle. Thermoplastic SMPs “creep,” which mean they gradually “forget” their respective memory shapes over time.

While SMAs and SMPs appear to operate similarly on the macro scale, at the molecular scale the method of operation of each is very different. The difference between SMAs and SMPs at the molecular level is in the linkages between molecules. SMAs essentially have fixed length linkages that exist at alternating angles establishing a zigzag patterned molecular structure. Reshaping is achieved by straightening the angled connections from alternating angles to straight forming a cubic structure. This method of reshaping SMA material enables bending while limiting any local strains within the SMA materials to less than eight percent (8%) strain, as the maximum shape memory strain for SMA is eight percent (8%). This eight percent (8%) strain allows for the expansion or contraction of the SMA by only 8%, a strain that is not useful for most industrial applications. Recovery to memory shape is achieved by heating the material above a certain temperature at which point the molecules return to their original zigzag molecular configuration with significant force thereby reestablishing the memory shape. The molecular change in SMA is considered a metallic phase change from Austenite to Martensite, which is defined by the two different molecular structures.

SMPs have connections between molecules with some slack. When heated, these links between connections are easily contorted, stretched, and reoriented due to their elastic nature as the SMP behaves like an elastic material when heated, and when cooled, the shape is fixed to how it was being held. In the cooled state the material behaves as a typical rigid polymer that was manufactured in that shape. Once heated the material again returns to the elastic state and can be reformed or returned to the memory shape with very low force. Unlike SMAs, which possess two different molecular structures, SMPs are either a soft elastomer when heated, or a rigid polymer when cool. Both SMAs and SMPs can be formulated to adjust the activation temperature for various applications.

Unlike SMAs, SMPs exhibit a radical change from a normal rigid polymer to a flexible elastic and back on command. SMAs would be more difficult to use for most applications because SMAs do not easily change activation temperatures as do SMPs. SMAs also have issues with galvanic reactions with other metals, which would lead to long term instability. The current supply chain for SMAs is also not consistent. SMP materials offer the stability and availability of a plastic and arc more inert than SMAs. Additionally, when made into a composite, SMPs offer similar, if not identical, mechanical properties to that of traditional metals and SMAs in particular.

The term “activate” means to enable the DMR to switch from a high elastic modulus to a low elastic modulus, while the term “deactivate” means to enable the DMR to switch from a low elastic modulus to a high elastic modulus. The DMR can be activated or deactivated via thermal, light, water, electromagnetic radiation, or other means that will induce the DMR matrix to change its elastic modulus from a hard state to a soft state and reverse that state upon application of the opposite stimulus. For thermally activated DMRs, the stimulus can be the application and removal of heat. For electromagnetic radiation activated DMRs, the stimulus can be application of one wavelength and energy of light, and then the application of a second wavelength and energy of light. Regardless of the activation means, the Tg is altered by the application or removal of the stimulus. As the Tg is lowered below the ambient temperature, the material can be easily deformed and reshaped, and then the Tg is raised so the material returns to its hard state.

### SUMMARY OF THE INVENTION

In one embodiment, the invention is concerned with a method of forming a composition, where the method comprises reacting a bismaleimide with a diamine to form a polyaspartimide. The reaction is carried out in an environment that is substantially free of non-reactive solvents.

In another embodiment, the invention provides a composition comprising a polyaspartimide including recurring monomers of

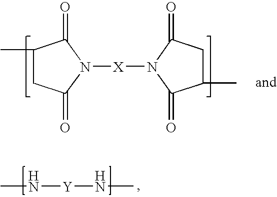

In this formula, X is selected from the group consisting of

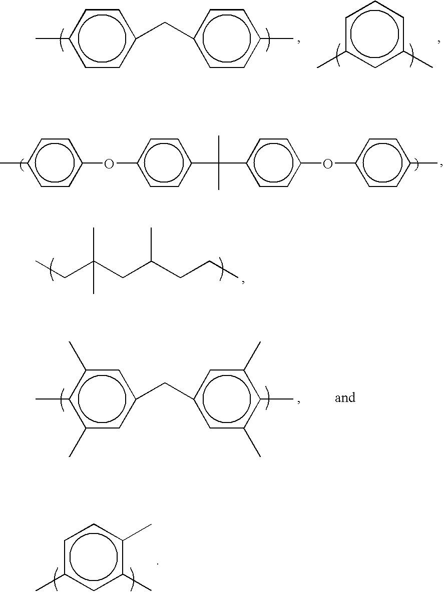

Furthermore, Y is selected from the group consisting of

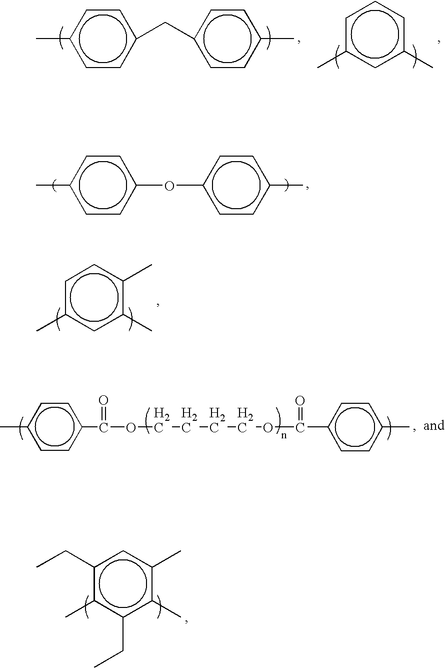

where n is 1 to about 10. This composition is substantially free of non-reactive solvents.

The invention provides a composite product comprising a material infused with a composition comprising a polyaspartimide.

Finally, the invention includes a shape memory polymer comprising a polyaspartimide and having: a Tg of at least about 150° C.; an elastic modulus at 25° C. of from about 2 GPa to about 5 GPa; and a % elongation of from about 5% to about 150%.

### BRIEF DESCRIPTION OF THE DRAWINGS

Figure (FIG.) 1 is a graph showing the ramp temperature and viscosity data for the composition of Example 1;

FIG. 2 is a graph depicting the soak test results of the composition of Example 1;

FIG. 3 is a graph illustrating the stress versus strain test results of the composition of Example 1;

FIG. 4 is a graph of the storage modulus data of the composition of Example 1;

FIG. 5 is a graph showing the elongation data of the composition of Example 1;

FIG. 6 is a differential scanning calorimetry plot used to determine the Tg of the composition of Example 2;

FIG. 7 is a graph showing the elongation data of the composition of Example 2;

FIG. 8 is a graph depicting the ramp temperature and viscosity data for the composition of Example 2;

FIG. 9 is a graph illustrating the soak test results of the composition of Example 2;

FIG. 10 is a graph showing the stress versus strain test results of the composition of Example 4;

FIG. 11 is a differential scanning calorimetry plot used to determine the Tg of the composition of Example 4; and

FIG. 12 is a graph showing the strain data of the composition of Example 4.

### DETAILED DESCRIPTION OF THE PREFERRED EMBODIMENTS

The present invention is concerned with a polyaspartimide composition, methods of forming these compositions, and articles of manufacture containing these compositions. In more detail, the composition is formed by reacting a bismaleimide (also referred to as “BMI”) with a diamine to form a polyaspartimide.

Preferred bismaleimides have the formula

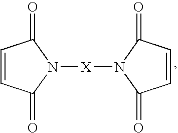

where X is selected from the group consisting of

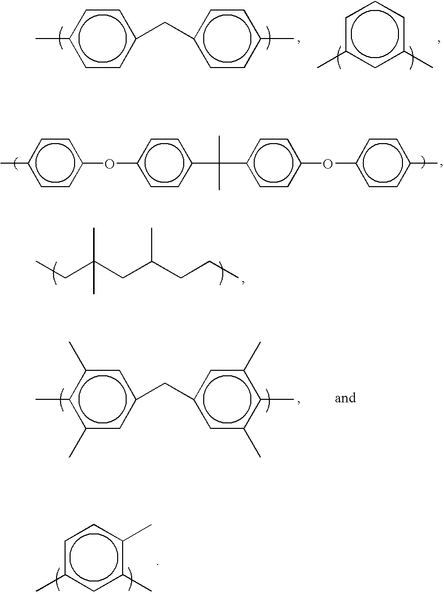

Preferred diamines have the formula

H₂N—Y—NH₂,

where Y is selected from the group consisting of

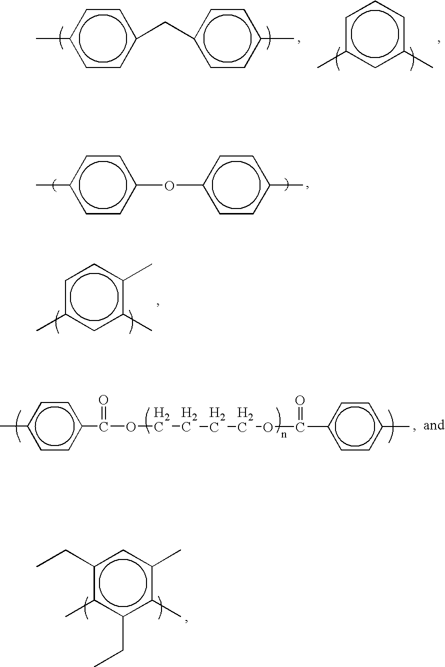

where n is 1 to about 10.

It is preferred that the reacting step be carried out by first heating the ingredients at a temperature and for a time period that will melt those ingredients. Polymerization is then carried out by heating at a temperature range of from about 100° C. to about 200° C., and preferably from about 125° C. to about 175° C., for a time period of from about 2 hours to about 6 hours, and preferably from about 3 hours to about 5 hours. After polymerization, the polymer is preferably subjected to a post-cure step by heating at a temperature range of from about 180° C. to about 250° C., and preferably from about 210° C. to about 230° C., for a time period of from about 2 hours to about 6 hours, and preferably from about 3 hours to about 5 hours.

It is further preferred that the above reactions take place in an environment that is substantially free (i.e., less than about 0.1% by weight and preferably about 0% by weight) of non-reactive solvents. As used herein, “non-reactive solvent” refers to one that docs not react with the bismaleimide or diamine during the reaction process. These include typical solvents used during polymerization reactions such as acetone, alcohol, toluene, methyl ethyl ketone, acetic acid, and mixtures thereof.

As used herein, a “reactive solvent” is one that reacts with the bismaleimide and/or diamine so as to form a part of the polymer during the reaction process, with the reactive solvent being consumed during this reaction by reacting with another component present in the system. Thus, in preferred embodiments, the reactive solvent acts as a co-monomer. When a reactive solvent is utilized, it should be present at levels of from about 5% to about 60% by weight, and preferably from about 30% to about 50% by weight, based upon the total weight of the polymer resin taken as 100%) by weight. Suitable reactive solvents include those selected from the group consisting of diallylbisphenol-A, epoxies (e.g., diglycidyl ether of bisphenol A, diglycidyl ether of bisphenol F, diglycidyl ether of resorcinol), and mixtures of the foregoing. By avoiding the use of non-reactive solvents typically used in the prior art, the present invention provides a significant advantage in that harmful by-products are avoided. That is, each of the components in the reaction system react with one another so that by-products arc not generated or released. This improves part quality and also simplifies the process.

Although in some embodiments various optional ingredients can be included in the reaction environment, in preferred embodiments, the reaction environment only includes the bismaleimide(s), diamine(s), and any reactive solvent(s) that are utilized. The reaction system is substantially free (i.e., less than about 0.1% by weight, and preferably about 0% by weight, based upon the total weight ofthe bismalcimide(s) and diamine(s) taken as 100% by weight) of one or all of the following: crosslinking agents, catalysts, and photoinitiators. In one embodiment, the composition consists essentially of the polyaspartimide. In another embodiment, any reactive solvents or comonomers (e.g., epoxies) utilized in addition to the bismaleimide and diamine monomers do not include any vinyl groups.

The resulting polyaspartimide will preferably comprise recurring monomers having the formula

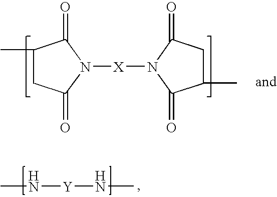

where X and Y are as defined above with respect to the starting monomers.

In one embodiment, the polyaspartimide comprising recurring monomers

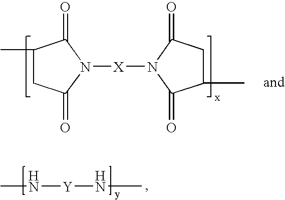

wherein the molar ratio of x:y is from about 3:1 to about 1:3, preferably from about 2:1 to about 1:2, and more preferably from about 1.1:1 to about 1:1.1. These ratios also represent the preferred molar ratios of bismaleide:diamine during the reaction. Although comonomers such as those from any reactive solvent could be present in the polyaspartimide as discussed above, it is preferred that “x+y” comprises at least about 50% of the total monomers present in the polymer, more preferably at least about 70% of the total monomers present in the polymer, and even more preferably from about 70% to about 99% of the total monomers present in the polymer.

The resulting polyaspartimide and composition including the polyaspartimide possess a number of advantageous properties. For example, the polyaspartimide is a thermosetting polymer. The degree of crosslinking can be controlled by the use of a small excess of diamine. In this instance, from about 0.5% to about 3%, and preferably from about 1% to about 2% molar excess (relative to the quantity of bismaleimide(s) utilized) of the diamine would be included in the reaction environment. Or, the degree of crosslinking can be controlled by the use of a small amount of a tetra-functional epoxy compound (e.g., 4,4′-methylenebis(N,N-diglycidylaniline). In this instance, the epoxy compound would be included to provide from about 0.5% to about 3% by weight epoxy compound, and preferably from about 1% to about 2% by weight epoxy compound, based upon the total weight of the polymer resin taken as 100% by weight.

The Tg of the inventive polyaspartimides is advantageously at least about 150° C., preferably from about 170° C. to about 250° C., and even more preferably from about 190° C. to about 210° C. The elastic modulus of the polyaspartimide at 25° C. is from about 2 GPa to about 5 GPa, preferably from about 3.5 GPa to about 4.5 GPa, and more preferably from about 3.8 GPa to about 4.2 GPa. Furthermore, the % elongation of the polyasparlimide is from about 5% to about 150%, preferably from about 50% to about 150%, and more preferably from about 100% to about 150%. Furthermore, the viscosity of the composition at less than 100° C. is from about 100 cPs to about 1,000 cPs, preferably from about 150 cPs to about 800 cPs, and more preferably from about 200 cPs to about 500 cPs. These properties are determined following the procedures set forth in the Examples, which are discussed below.

Polyaspartimides or polyaspartimide compositions possessing the above properties (and the ability to control those properties) would be useful in a number of products. For example, one skilled in the art could adjust the degree of crosslinking as described above to yield properties (e.g., ultimate strain, recovery, elastic modulus) consistent with SMPs, if desired. Furthermore, these properties lend the inventive material to be used in composite products where a material is infused (typically physically) or impregnated with the polyaspartimide or polyaspartimide composition. Some materials that could be infused with the inventive composition include those selected from the group consisting of carbon fibers, glass fibers, polymeric fibers (e.g., aramids), and fabrics of the foregoing fibers. The properties of these inventive materials are such that they would work well with RTM processes, such as VARTM. Such infused products would find use in a number of industries, including the aeronautical industry for use in manufacturing airplanes (e.g., fuselage, wings).

### EXAMPLES

The following examples set forth preferred methods in accordance with the invention. It is to be understood, however, that these examples are provided by way of illustration and nothing therein should be taken as a limitation upon the overall scope of the invention.

### Example 1

### 1. Preparation of Composition

A formulation (see Table 1) was prepared with 1,1′-(methylenedi-4,1-phenylene)bismaleimide, 1,6-bismaleimide-2,2,4-trimethyl hexane, 3,3′-dichlor-4,4′-diaminodiphenylmethane, and diallylbisphenol-A. The 3,3′-dichlor-4,4′-diaminodiphenylmethane and diallylbisphenol-A were melted together at 80° C. while stirring, and the 1,1′-(methylenedi-4,1-phenylene)bismaleimide and 1,6-bismaleimide-2,2,4-trimethyl hexane were gradually added to the mixture. The temperature was then increased to 120° C. to completely melt the ingredients. The material was then polymerized at 150° C. for 4 hours and post-cured at 220° C. for 4 hours. The cured material showed a Tg greater than 150° C., while the resin retained the low viscosity necessary for VARTM processing. The material also showed SMP characteristics.

TABLE 1
Example 1 Formulation Data

| | PRODUCT | | |
|---|---|---|---|
| CHEMICAL | NAME | MOL % | WT % |
| 1,1′-(methylenedi-4,1- | BMI 1000^{A} | 30.00% | 34% |
| phenylene)bismaleimide | | | |
| 1,6-bismaleimide-2,2,4-trimethyl | BMI-TMH^{A} | 20.00% | 21% |
| hexane | | | |
| diallylbisphenol-A | DABA^{B} | 20.00% | 20% |
| 3,3′-dichlor-4,4′- | Curene 442^{C} | 30.00% | 25% |
| diaminodiphenylmethane | | | |

^{A}Obtained from Daiwakasei, of Osaki City, Japan.
^{B}Obtained from Sigma Aldrich, of St. Louis, MO.
^{C}Obtained from Anderson Development Company, of Adrian, MI.

### 2. Characterization of Composition

A. Rheology procedure

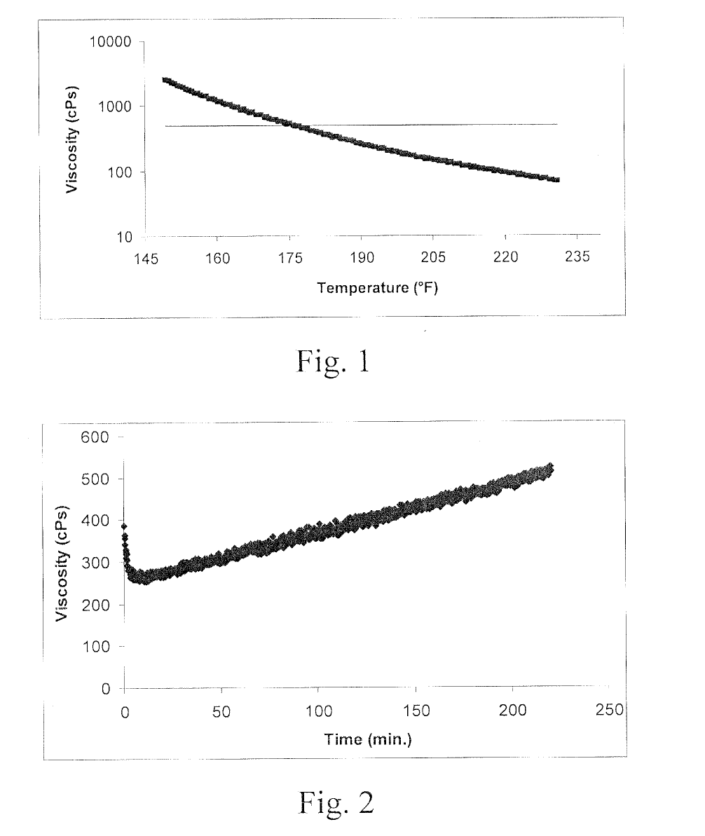

A rheometer (TA Instruments AR2000) was used to obtain viscosity profiles of the resin at different temperature ramps and time soaks. In both tests, the instrument geometry (stainless steel disc of 40 mm diameter) was set to a gap of 0.750 mm, and the angular velocity was set to 0.3927 rad/sec. Approximately 1.05 mL of material was injected onto the Peltier plate (heat control device), and the instrument geometry was lowered onto the material, sandwiching the material between the geometry and Peltier plate. For the ramp (FIG. 1), the viscosity was sampled every 10 seconds, and the temperature was ramped 9° F. per minute from 140° F. to 230° F. In the soak test (FIG. 2), the material soaked at 185° F. for 6 hours. The soak test gives an indication of potlife at process temperature.

B. DMA Three-Point Bend Procedure

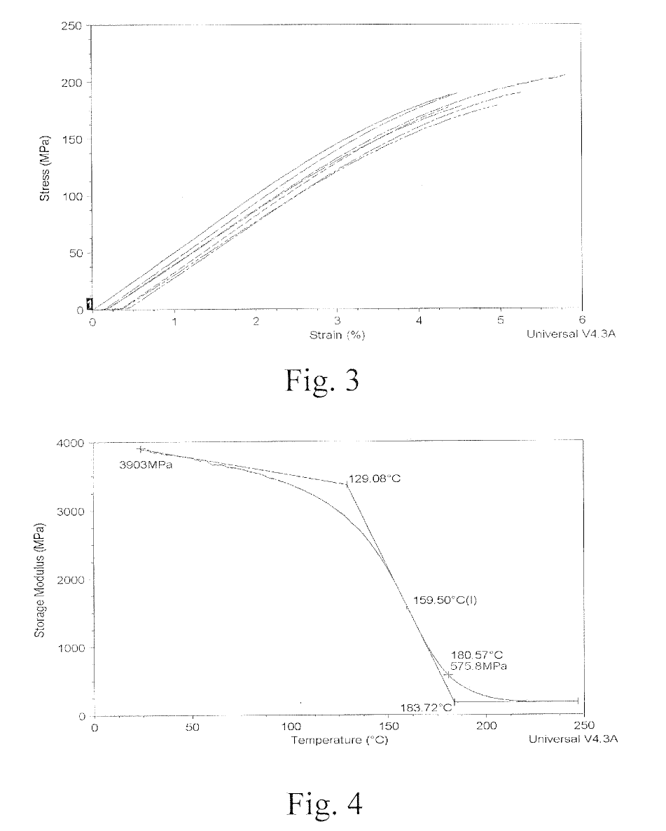

A 3-point bend procedure (developed by Cornerstone Research Group, Inc., Dayton, Ohio) was used on a dynamic mechanical analyzer (DMA) in order to acquire mechanical strength and modulus data without having to scale up the material for testing according to ASTM standards. To prove the accuracy of the test, materials of known properties were tested using the established procedure, and the results were compared to published values. Samples were tested using the controlled stress/strain method with a force rate of 5 N/min and a sampling rate of 1.0 point/sec. The samples were ramped until the sample failed or the maximum force of the DMA (18N) was reached. Sample dimensions were 20 mm (l)×2.65 mm (w)×0.80 mm (h). The data was analyzed using TA instruments universal analysis. The maximum strength was taken to be the maximum value in the plateau region of the stress versus strain plot. Tire modulus was taken to be the slope of the stress versus strain plot in the initial elastic (linear) region. Table 2 shows mechanical data gathered from the test. FIG. 3 shows stress versus strain plots of multiple test specimens of the same material.

TABLE 2
Three-Point Bend Data

| | Elastic | Elastic | Max | Max |
|---|---|---|---|---|
| | Modulus | Modulus | Strength | Strength |
| Cure Cycle | (GPa) | (Ksi)^{A} | (Mpa) | (Ksi) |
| Average | 4.92 | 713 | 187 | 27.2 |
| Standard | 0.13 | 18.5 | 8.4 | 1.2 |
| Deviation | | | | |

^{A}Kilopounds per square inch.

C. Tg Determination Procedure

The Tg of the material was determined via a single cantilever test on the DMA. The temperature was ramped at 5° C./min from room temperature to 245° C. The storage modulus is an indication of the stiffness of the material. Sample dimensions were 17.20 mm (l)×2.66 mm (w)×0.87 mm (h). The Tg was identified as the inflection point of the storage modulus versus temperature plot. FIG. 4 shows the storage modulus versus temperature plot.

D. Ultimate Elongation of Material

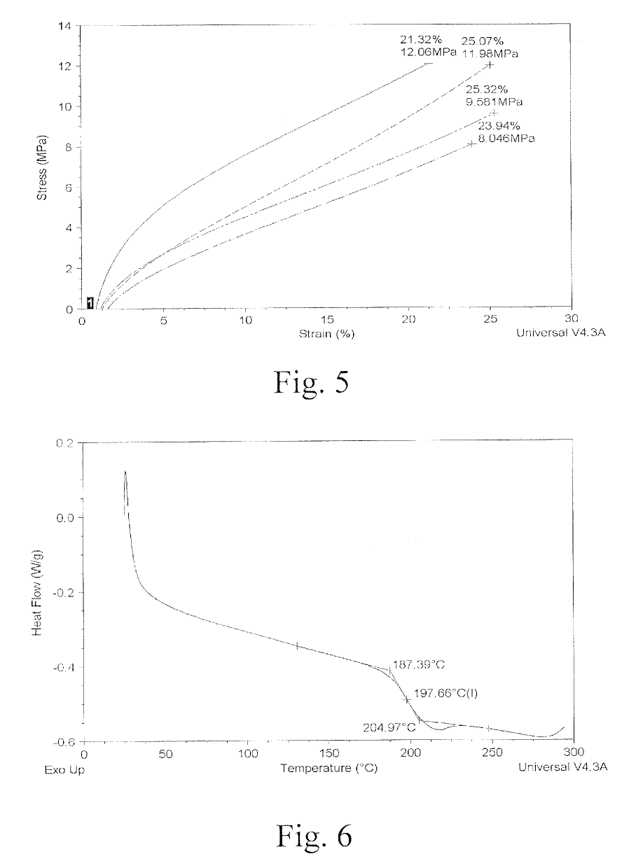

An ultimate elongation test was performed on the DMA in tension film mode. Sample dimensions were 9.19 mm (l)×5.04 mm (w)×0.20 mm (h). The sample was mounted in the instrument clamp and heated to 30° C. above the Tg (220° C.), and the force was ramped at 3 N/min until the sample failed. The true strain (natural log of the final length divided by the initial length) was calculated using Universal Analysis. The true strain gives a value smaller than the engineering strain (the difference in initial and final length divided by the initial length). FIG. 5 shows tests of multiple specimens of the same material.

H. Material Recovery

To demonstrate the ability to elongate and recover from deformation, a qualitative test was performed using a heat gun and millimeter-scale ruler. The sample was heated using a heat gun until the material was rendered flexible. The material was then strained by hand to an arbitrary point near failure. During the first strain cycle, the middle section of the sample was marked in two locations, and the distance between the markings was measured using the ruler. In the recovered shape, the distance between markings was measured again, giving 11 mm. The material was repeatedly heated/stretched/cooled/heated/cooled, giving about 17 mm in the elongated state, and 11 mm in the recovered state. The distance stretched and the recovered dimensions were repeatable. Thus, the sample showed an elongation of 60 percent.

### Example 2

### 1. Preparation of Composition

A formulation (see Table 3) was prepared with 1,1′-(methylenedi-4,1-phenylene)bismaleimide and 4,4′-diaminodiphenylmethane by melting the two ingredients while mixing. The material was polymerized by heating to 120° C. for 4 hours and post-curing at 190° C. for 4 hours. The cured material showed a Tg over 200° C. and exhibited a true strain of 80 percent with recovery (via thin film ultimate strain on dynamic mechanical analyzer (DMA)).

TABLE 3
1:1 BMI:MDA formulation

| Chemical | Product Name | Mol % | Wt % |
|---|---|---|---|
| 1,1′-(methylenedi-4,1- | BMI 1000 | 50.00% | 64.4% |
| phenylene)bismaleimide | | | |
| 4,4′-diaminodiphenylmethane | MDA^{A} | 50.00% | 35.6% |

^{A}Obtained from Sigma Aldrich, of St. Louis, MO.

### 2. Characterization of Composition

A. 3-Point Bend Procedure

This analysis was carried out using the procedure described in Example 1. Sample dimensions were 20 mm (l)×2.65 mm (w)×0.80 mm (h). Table 4 gives the mechanical properties of this material.

TABLE 4
Thermal and Mechanical Testing Data

| | Elastic | Elastic | Max | Max |
|---|---|---|---|---|
| | Modulus | Modulus | Strength | Strength |
| | (GPa) | (Ksi) | (Mpa) | (Ksi) |
| Average | 3.51 | 509 | 152 | 22.1 |
| Standard | 0.144 | 20.9 | 16.3 | 2.36 |
| Deviation | | | | |

B. Tg Determination

The Tg was determined via differential scanning calorimetry (DSC). Using an approximately 10-mg sample, the temperature was ramped from room temperature to 300° C. at 20° C. per minute. The inflection point of the heat flow versus temperature plot was identified as the Tg. FIG. 6 shows the DSC plot and a Tg of about 200° C.

C. Ultimate Elongation

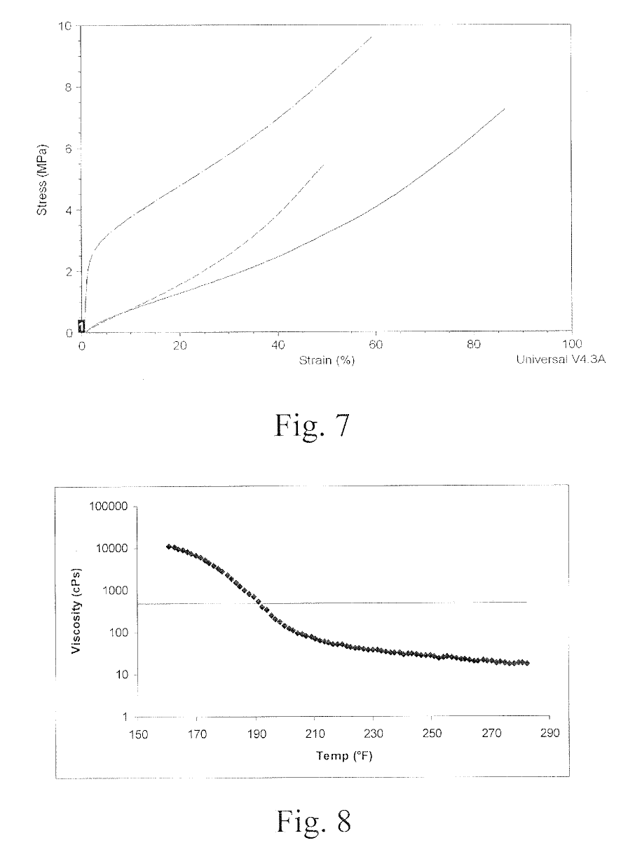

The ultimate elongation was determined using the procedure described in Example 1. Sample dimensions were 9.19 mm (l)×5.04 mm (w)×0.20 mm (h). FIG. 7 sets forth these results.

### Example 3

A formulation was prepared with 66% by weight 1,6-bismaleimide-2,2,4-trimethyl hexane monomer and 34% by weight mixture of dicthyltoluenediamine isomers. The material was heated to 80° C. while stirring until the 1,6-bismaleimide-2,2,4-trimethyl hexane and diethyltoluenediamine formed a homogeneous mixture. The material was polymerized by heating to 120° C. for 4 hours and post-curing at 190° C. for 4 hours. The cured material showed a Tg of over 150° C. and gave excellent mechanical properties, while the resin retained the low viscosity necessary for VARTM processing. The material also showed SMP characteristics.

### Example 4

### 1. Preparation of Composition

A formulation was prepared as described in Example 3, except that the formulation of the composition was as shown in Table 5.

TABLE 5
BMI-TMH/Ancamine Z/Ancamine DL-50 Formulation

| Chemical | Product Name | Mol % | Wt % |
|---|---|---|---|
| 1,6-bismaleimide-2,2,4-trimethyl | BMI-TMH | 50.00% | 78.5% |
| hexane | | | |
| Mixture of 1,3-phenylenediamine, | Ancamine Z^{A} | 10.00% | 4.10% |
| 4,4′-diaminodiphenylmethane and | | | |
| other proprietary chemicals | | | |
| Mixture of 4,4′- | Ancamine | 40.00% | 17.40% |
| diaminodiphenylmethane and | DL-50^{A} | | |
| polymeric | | | |
| 4,4′-diaminodiphenylmethane | | | |

^{A}Obtained from Air Products, of Allentown, PA.

### 2. Characterization of Composition

A. Rheology Procedure

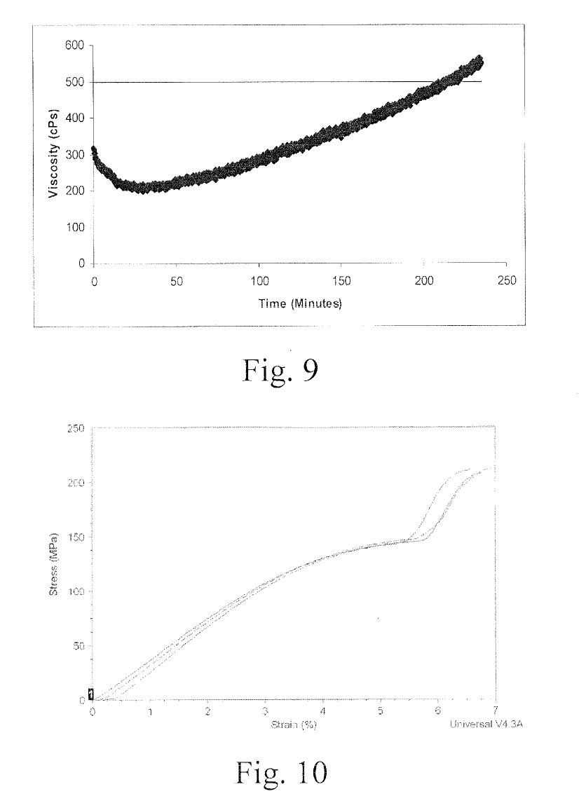

The procedure followed to determine the rheology was that described above in Example 1. For the soak, the material was soaked at 175° F. for 6 hours. FIGS. 8 and 9 show the temperature ramp and soak, respectively.

B. Three-Point Bend Procedure

This analysis was carried out using the procedure described in Example 1. Sample dimensions were 20 mm (l)×2.65 mm (w)×0.80 mm (h). Table 6 shows the mechanical data gathered. FIG. 10 shows multiple runs for different specimens from the same material.

TABLE 6
Mechanical Testing Data for BMI-TMH/Ancamine Z/Ancamine DL-50

| Elastic Modulus | Elastic Modulus | Max Strength | Max Strength |
|---|---|---|---|
| (GPa) | (Ksi) | (Mpa) | (Ksi) |
| 4.05 | 587 | 145 | 21.1 |

C. Tg Determination Procedure

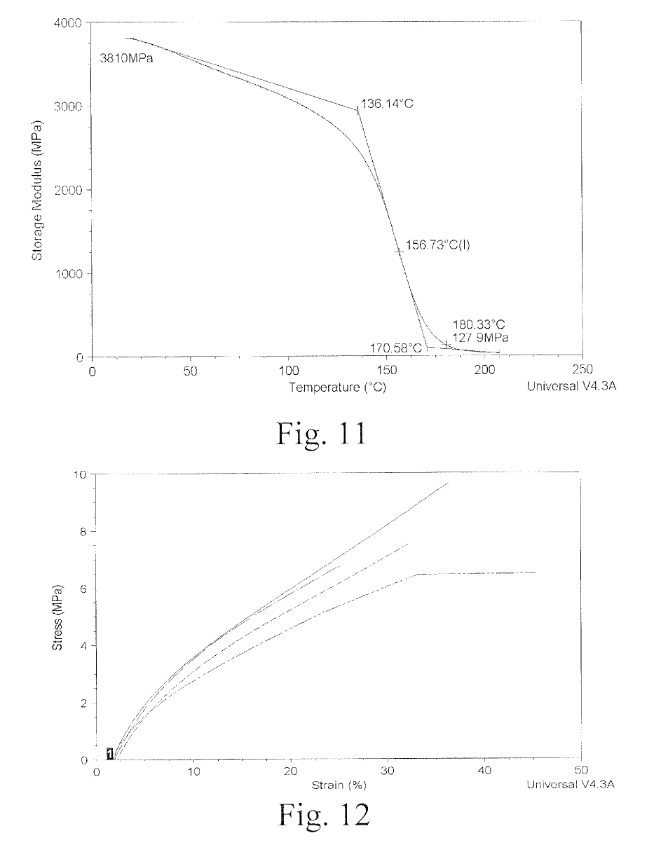

A DMA was used to determine the Tg as described in Example 1. Sample dimensions were 17.94 mm (l)×4.96 mm (w)×1.50 mm (h). The temperature was ramped at 5° C. per minute from room temperature to 210° C. FIG. 11 shows the storage modulus versus temperature plot.

D. Ultimate Elongation of Material

This procedure was carried about as described in Example 1. Sample dimensions were 9.19 mm (l)×5.04 mm (w)×0.20 mm (h). FIG. 12 shows stress/strain plots for multiple specimens of the same material.

We claim:

1. A method of forming a composition, said method comprising reacting a bismaleimide with a diamine in an environment that is substantially free of non-reactive solvents, said reacting resulting in the formation of a polyaspartimide.

2. The method of claim 1, wherein:
said bismaleimide has the formula 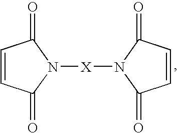
where X is selected from the group consisting of 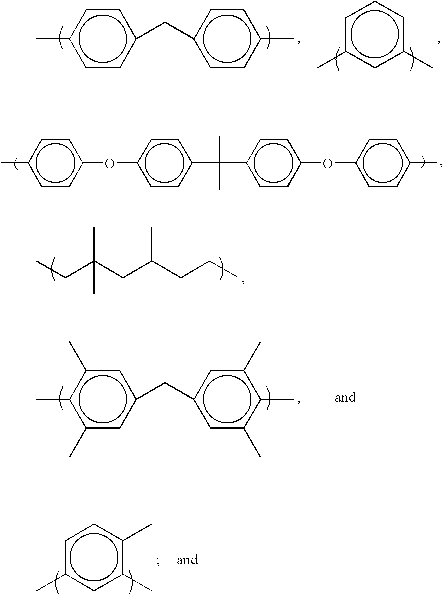
said diamine has the formula
H₂N—Y—NH₂,
where Y is selected from the group consisting of 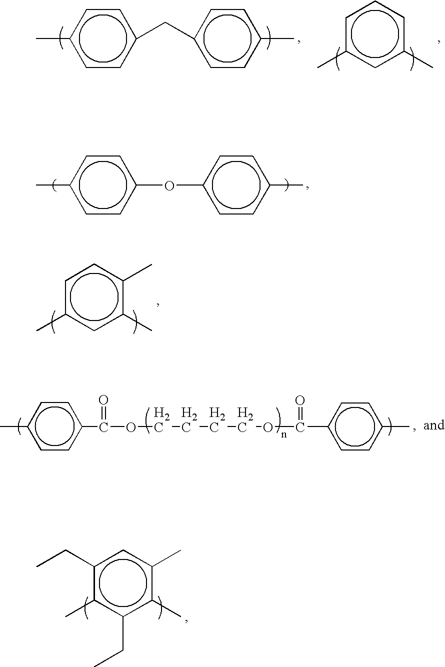
where n is 1 to about 10.

3. The method of claim 1, wherein said polyaspartimide comprises recurring monomers of 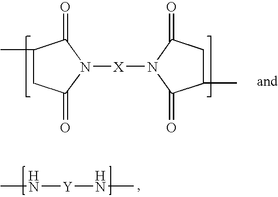
where:
X is selected from the group consisting of 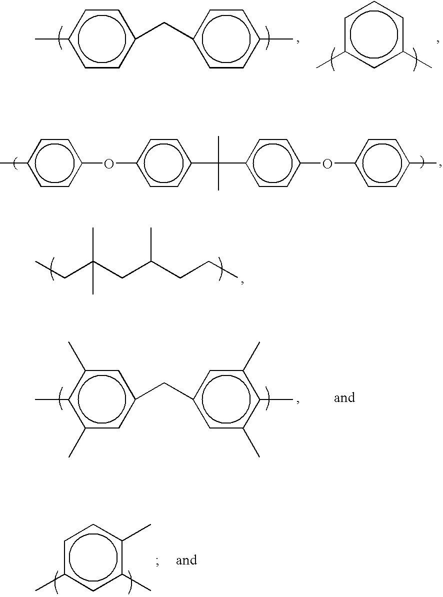
Y is selected from the group consisting of 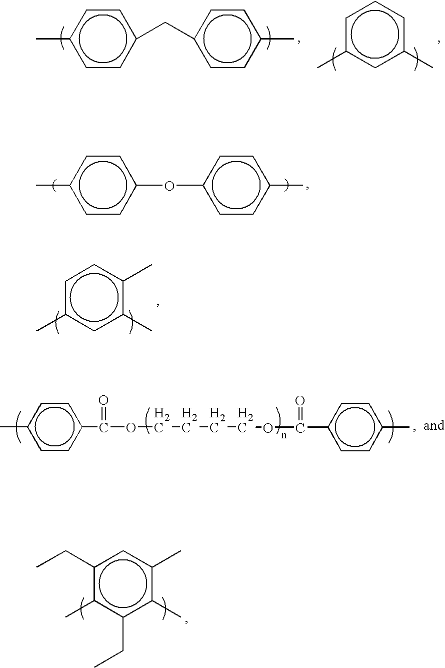
where n is 1 to about 10.

4. The method of claim 1, wherein said bismaleimide and diamine are reacted at a molar ratio of from about 3:1 to about 1:3.

5. The method of claim 1, wherein said polyaspartimide is a thermosetting polyaspartimide.

6. The method of claim 1, wherein said polyaspartimide exhibits a % elongation of from about 5% to about 150%.

7. A composition comprising a polyaspartimide having recurring monomers of 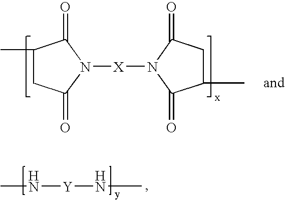
where:
X is selected from the group consisting of 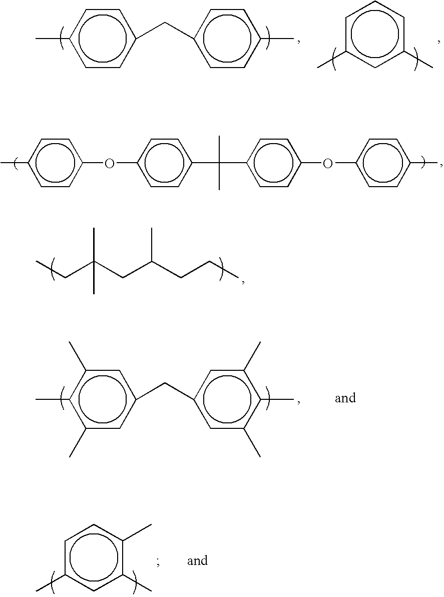
Y is selected from the group consisting of 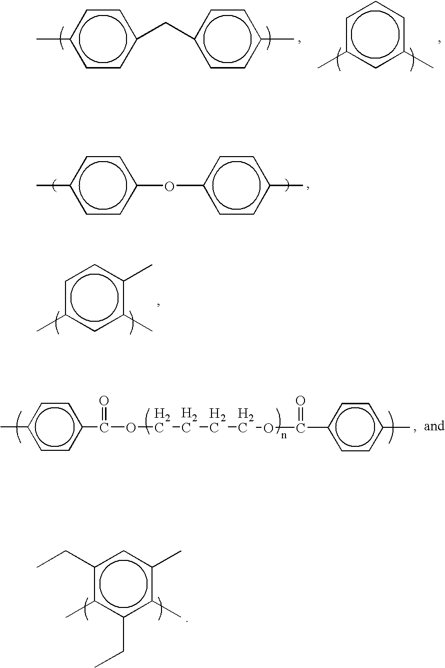
where n is 1 to about 10,
said composition being substantially free of non-reactive solvents.

8. The composition of claim 7, wherein said composition consists essentially of said polyaspartimide.

9. The composition of claim 7, wherein x and y are present at a molar ratio of from about 3:1 to about 1:3.

10. The composition of claim 7, wherein said polyaspartimide is a thermosetting polyaspartimide.

11. The composition of claim 7, wherein said polyaspartimide exhibits a % elongation of from about 5% to about 150%.

12. A composite product comprising a material infused with a composition comprising a polyaspartimide.

13. The product of claim 12, wherein said polyaspartimide comprises recurring monomers of 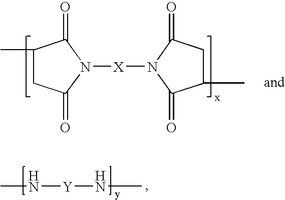
where:
X is selected from the group consisting of 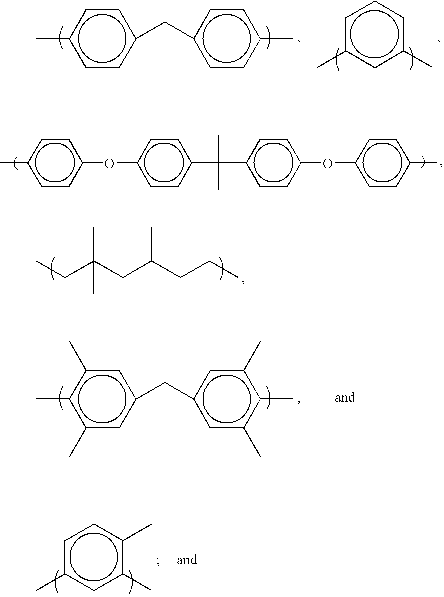
Y is selected from the group consisting of 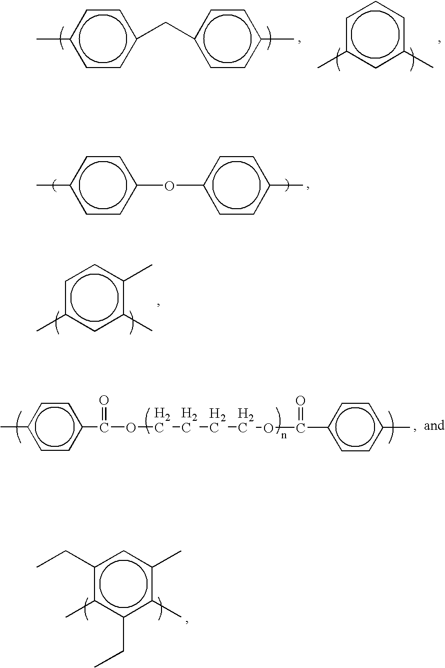
where n is 1 to about 10,
said composition being substantially free of non-reactive solvents.

14. The product of claim 12, wherein said material is selected from the group consisting of carbon fibers, glass fibers, polymeric fibers, and fabrics of the foregoing fibers.

15. The product of claim 12, wherein said composition consists essentially of said polyaspartimide.

16. The product of claim 13, wherein x and y are present at a molar ratio of from about 3:1 to about 1:3.

17. The product of claim 12, wherein said polyaspartimide is a thermosetting polyaspartimide.

18. The product of claim 16, wherein said polyaspartimide exhibits a % elongation of from about 5% to about 150%.

19. A shape memory polymer comprising a polyaspartimide and having:
a Tg of at least about 150° C.;
an elastic modulus at 25° C. of from about 2 GPa to about 5 GPa; and
a % elongation of from about 5% to about 150%.
